(19) United States
(12) Patent Application Publication
(10) Pub. No.: US 2025/0375061 A1
(43) Pub. Date: Dec. 11, 2025

(54) MANUFACTURING SYSTEM FOR COFFEE WITH BUBBLES

(71) Applicant: Jong-hyun Park, Seoul (KR)

(72) Inventor: Jong-hyun Park, Seoul (KR)

(21) Appl. No.: 19/227,485

(22) Filed: Jun. 4, 2025

(30) Foreign Application Priority Data
Jun. 5, 2024 (KR) 10-2024-0073881

(51) Int. Cl. A47J 31/44

(52) U.S. Cl. CPC A47J 31/4496

(57) ABSTRACT

The present invention relates to a manufacturing system for coffee with bubbles with improved structure to ensure coffee with bubbles can be manufactured by mixing only external air that is harmless to the human body and that consumers can trust without the need for injecting nitrogen gas, and rich foam can be manufactured by mixing external air into the coffee concentrate side using the pressure of the pump in the process of pressurizing and conveying coffee concentrate by the pressure of the pump, and by passing the coffee concentrate mixed with external air through the first and second orifices placed in series in the transfer hose.

### CROSS REFERENCE TO RELATED APPLICATIONS

The present disclosure claims the priority of Korean Patent Application No. 10-2024-0073881 filed on Jun. 5, 2024. All the above are hereby incorporated by reference in their entirety.

### TECHNICAL FIELD

The present invention relates to a manufacturing system for coffee with bubbles, and more specifically, to a manufacturing system for coffee with bubbles in which coffee with bubbles can be manufactured by mixing only external air that is harmless to the human body and that consumers can trust, without the need to inject nitrogen gas, and in which the structure of the manufacturing system for coffee with bubbles is improved to ensure external air is mixed into the coffee concentrate side by using the pressure of the pump in the process of pressurizing and conveying the coffee concentrate by the pressure of the pump, and the coffee concentrate mixed with external air passes through the first and second orifices placed in series to the transfer hose to produce rich foam.

### BACKGROUND ART OF THE INVENTION

In general, coffee is provided to consumers in various forms, and the demand for a machine which enables users to take coffee that meets their taste with simple operation regardless of time and place is also rapidly increasing.

Meanwhile, some people prefer coffee with bubbles depending on their taste. However, the vending machine does not have a function which a barista can manually form bubbles in coffee, which requires more research and development.

One of the existing prior art for forming coffee with bubbles, as published in Korean Patent Gazette No. 10-2027463, “Manufacturing Method of Liquid Coffee forming having Foam Layer and Liquid Coffee by the Same” (Registration date: Sep. 25, 2019), is to produce liquid coffee forming a foam layer through a nitrogen gas injection step for forming a gas mixture extract by injecting nitrogen gas into a coffee extract, and a liquid nitrogen injection step for manufacturing liquid coffee by injecting liquid nitrogen into the gas mixture extract.

However, even if the above nitrogen gas is not harmful to the human body, it is not likely to have a good effect on the human body when inhaled or drunk, and has the disadvantage of not meeting the taste of consumers.

Another prior art related to existing coffee with bubbles, as disclosed in Korean Patent Gazette No. 10-2463991 “Coffee Banding Machine That Provides Coffee with Bubbles Generated by User's Cooking Selection by Controlling Pressure of Pump and Discharge Area of Nozzle” (Registration date: Nov. 2, 2022), is equipped with a plurality of nozzles mounted in a case and independently connected by a plurality of tanks and a plurality of channels to discharge coffee selected from the user interface and a pump built into the case and providing pressure to move coffee stored in the plurality of tanks to the plurality of nozzles, controls the amount of bubbles by controlling the pressure of the pump and the discharge area of the nozzles but has a concern that malfunctions may occur frequently since the pressure control of the pump and the control of the discharge areas of the plurality of nozzles are operated in conjunction with each other, and there is also a disadvantage that the work of controlling the discharge areas of the plurality of nozzles is cumbersome.

### PRIOR ART LITERATURE

### Patent Literature

(Patent Literature 0001) Korean Patent Gazette No. 10-2027463 ““ Manufacturing Method of Liquid Coffee forming having Foam Layer and Liquid Coffee by the Same” (Registration date: Sep. 25, 2019) (Patent literature 0002) Korean Patent Gazette No. 10-2463991 “Coffee Banding Machine That Provides Coffee with Bubbles Generated by User's Cooking Selection by Controlling Pressure of Pump and Discharge Area of Nozzle” (Registration date: Nov. 2, 2022)

### DESCRIPTIONS ON THE INVENTION

### Task to be Solved

The present invention was created to solve the above problems, and its purpose is to provide a manufacturing system for coffee with bubbles with the improved structure to ensure bubble coffee can be manufactured by mixing only external air without injecting nitrogen gas, and external air is mixed into the coffee concentrate side in the process of pumping the coffee concentrate by the pressure of the pump by using the pressure of the pump, and rich foam can be manufactured by passing the coffee concentrate mixed with external air through the first and second orifices.

### Means for Solving the Task

The present invention for achieving the above purpose is characterized by being equipped with a storage tank holding coffee concentrate, a transfer hose for sucking and conveying coffee concentrate from the storage container by the pressure of a pump, an outside air suction pipe connected to the transfer hose so as to be positioned in front of the pump and for mixing outside air into the transfer hose by the pumping pressure of the pump to create bubbles in the coffee concentrate, a control valve placed in the outside air suction pipe for controlling the amount of outside air to be sucked into the transfer hose, and first and second orifices placed in series within the transfer hose on the rear side of the pump to form bubbles making cavity of the coffee concentrate to be conveyed.

The first and second orifices are further equipped with an air inlet connected to the outside to mix outside air into the inside of the venturi nozzle of which pipe width narrows on the inner peripheral surface, and an on-off valve for controlling the amount of outside air mixed into the inside of the first and second orifices through the air inlet.

### Effect of the Invention

The present invention has the useful advantage of mixing outside air that is harmless to the human body and that consumers can trust, into the transfer hose in the course of conveying the coffee concentrate with the pumping pressure of the pump without the need to inject nitrogen gas, and at the same time, form a soft and rich foam layer by imparting a homo effect to the coffee concentrate through the process of passing it through the first and second orifices placed in series.

In addition, the present invention has the advantage of being able to create richer foam in the coffee concentrate when more air inlets and on-off valves are equipped with at the first and second orifices.

### BRIEF DESCRIPTION OF THE DRAWINGS

FIG. 1 is a schematic diagram showing the configuration of a manufacturing system for coffee with bubbles according to the present invention.

FIG. 2 is a schematic diagram showing the configuration of the first and second orifices of the present invention.

FIG. 3 is a diagram showing another embodiment of the first and second orifices of the present invention.

### SPECIFIC DETAILS FOR EMBODYING THE INVENTION

In describing the present invention, if it is determined that the specific descriptions of related published arts or configurations may unnecessarily obscure the points of the present invention, the detailed descriptions thereto will be omitted. In addition, the terms described below are terms defined after considering their functions in the present invention and may vary depending on the user's intention or custom, etc. Therefore, the definitions should be made based on the contents throughout this specification. In addition, ‘including’ a certain component does not exclude other components unless otherwise specifically stated, but means that other components may be included without limitation.

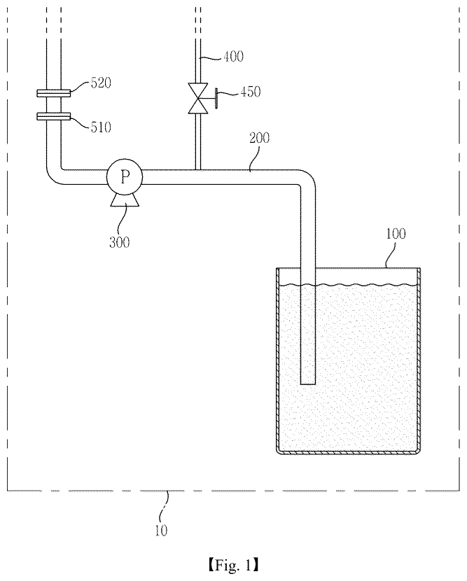

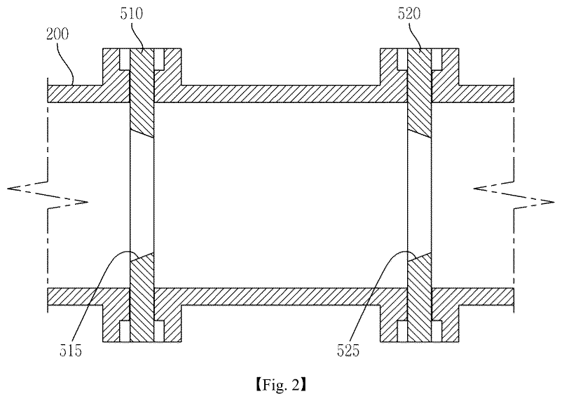

To describe by referring to with reference to FIGS. 1 and 2, the manufacturing system for coffee with bubbles according to the present invention consists of a storage container (100) holding coffee concentrate; a transfer hose (200) for sucking and transferring coffee concentrate from the storage container (100) by the pressure of a pump (300); an outside air suction pipe (400) connected to the transfer hose (200) so as to be positioned in front of the pump (300) and for mixing outside air into the inside of the transfer hose (200) by the pumping pressure of the pump (300) to create bubbles in the coffee concentrate; a control valve (450) placed in the outside air suction pipe (400) for controlling the amount of outside air sucked into the transfer hose (200); and the first and second orifices (510, 520) placed in series within the transfer hose (200) at the rear side of the pump (300) for creating bubbles by making the cavity of the coffee concentrate to be conveyed.

Here, the manufacturing system for coffee with bubbles relates to a device including a coffee machine (10).

Referring to FIG. 1 and FIG. 2, the storage container (100) is placed inside the coffee machine (10) and the coffee concentrate is contained inside.

One end of the transfer hose above (200) is engaged with the storage container (100) to suck the coffee concentrate inside the storage container (100) by the pressure of the pump (300), and the other end is connected to the outlet of the coffee machine (10).

The transfer hose (200) is composed of a flexible synthetic resin material.

In addition, the above pump (300) sucks the coffee concentrate in the storage container (100) with a pumping pressure of 8˜ 10 bar and conveys it to the outlet side of the coffee machine (10) through the transfer hose (200).

If the pumping pressure of the pump (300) is less than 8 bar, the transfer pressure of the coffee concentrate decreases and therefore a sufficient cavitation effect cannot be obtained. If it exceeds 10 bar, excessive pressure is applied thereby causing an overload in the pump (300).

The above outside air suction pipe (400) is positioned between the pump (300) and the storage container (100) and performs the function of mixing outside air into the transfer hose (200) where vacuum pressure is generated by the pumping pressure of the pump (300).

In addition, the above outside air suction pipe (400) is equipped with a control valve (450) that controls mixing of outside air in the transfer hose (200).

The above control valve (450) may adopt a micro needle valve for fine control of the amount of mixed outside air.

The above outside air suction pipe (400) performs the function of making cavity of the coffee concentrate in the transfer hose (200) by generating a homo effect due to the vacuum pressure generated by the pumping pressure of the pump (300).

The first and second orifices above (510, 520) are placed in series at the rear place of the pump (300) in the direction of coffee concentrate flow, and the nozzle parts (515, 525) are formed respectively to ensure the width within the pipe of the transfer hose (200) is narrowed.

The first and second orifices above (510, 520) are conveyed by the pumping pressure of the pump (300) and the coffee concentrate mixed with outside air through the outside air intake pipe (400) is cavitated while passing through the nozzle parts (515, 525) to ensure a soft and rich foam may be generated by promoting bubble generation.

In the present invention with this configuration, when a switch (not illustrated) related to a bubble coffee production mode is operated in a coffee machine (10) according to the consumer's choice, the control unit drives the pump (300) and opens the control valve (450).

Then, the coffee concentrate in the storage container (100) is sucked through the transfer hose (200) by the pumping pressure when starting the pump (300), the outside air is mixed into the transfer hose (200) through the opened control valve (450) to make cavity of generating bubbles while the coffee concentrate is being transferred through the pump (300), and is then conveyed to the first and second orifices (510, 520) through the pump (300).

Then, the above coffee concentrate repeats the process where the flow rate increases while passing through the nozzle parts (515, 525) of the first and second orifices (510, 520) and, after passing through the nozzle parts (515, 525), the pressure decreases, thereby splitting fine bubbles and creating soft and rich foam.

Thereafter, the above coffee concentrate is supplied to the outside through the outlet of the coffee machine (10).

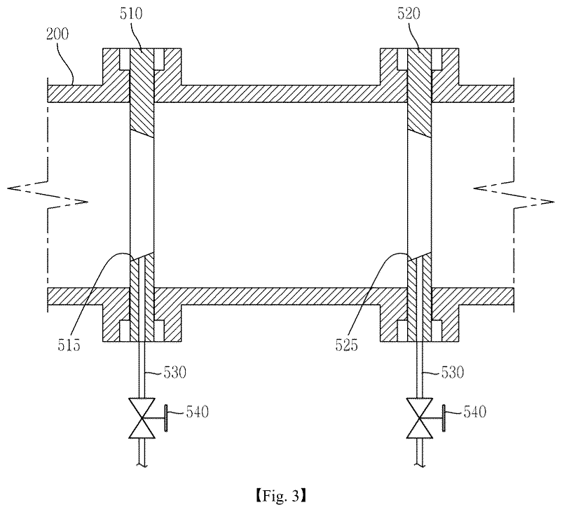

Meanwhile, FIG. 3 is a drawing showing another embodiment of the first and second orifices (510, 520) of the present invention, wherein the first and second orifices (510, 520) are each further equipped with an air inlet (530) that is connected to the outside to allow outside air to be mixed into the inside of a venturi nozzle of which inner periphery surface has a narrowed conduit width, and an on-off valve (540) that controls the amount of outside air mixed into the inside of the first and second orifices (510, 520) through the air inlet (530).

The first and second orifices (510, 520) of another embodiment of the present invention would generate more abundant foam in the coffee concentrate by naturally mixing outside air, which is harmless to the human body, into the inside of the transfer hose (200) according to the pressure change of the coffee concentrate passing through the nozzle parts (515, 525).

Therefore, the present invention has the useful advantage of being able to mix outside air, that is harmless to the human body and which consumers can trust, into the transfer hose (200) while the coffee concentrate is being conveyed by the pumping pressure of the pump (300) without the need for injecting nitrogen gas, and at the same time, through the process of passing the coffee concentrate through the first and second orifices (510, 520) placed in series, to have a homo effect on the coffee concentrate, and of forming a soft and abundant foam layer.

In addition, the present invention has the advantage of being able to generate richer foam in the coffee concentrate when the air inlet (530) and the on-off valve (540) are additionally equipped with at the first and second orifice sides (510, 520).

As above, in the detailed description of the present invention, specific embodiments have been described. Therefore, the scope of the present invention should not be limited to the embodiments described above, but should be determined not only by the patent claims described below but also by the equivalents of the claims.

That is, the present invention described above is not limited to the specific desirable embodiments described above, and anyone with ordinary knowledge in the technical field to which the present invention belongs can make various modifications not beyond the points of the present invention claimed in the claims, and such modifications are within the scope of the claims.

### DESCRIPTION OF THE SYMBOL

10: Coffee machine
100: Storage container
200: Transfer hose
300: Pump
400: Outside air intake pipe
450: Control valve
510,520: First and second orifices
515,525: Nozzle parts
530: Air inlet
540: On/Off valve

1. A manufacturing system for coffee with bubbles characterized by being equipped with
a storage container (100) holding coffee concentrate,
a transfer hose (200) for suctioning and transferring coffee concentrate from the storage container (100) by the pressure of a pump (300).
an outside air suction pipe (400) connected to the transfer hose (200) so as to be positioned in front of the pump (300) and for mixing outside air into the inside of the transfer hose (200) by the pumping pressure of the pump (300) to create bubbles in the coffee concentrate.
a control valve (450) placed in the outside air suction pipe (400) for controlling the amount of outside air sucked into the transfer hose (200), and
the first and second orifices (510, 520) placed in series within the transfer hose (200) at the rear side of the pump (300) for creating bubbles by making the cavity of the coffee concentrate to be conveyed

2. The manufacturing system for coffee with bubbles according to claim 1, characterized by being further equipped with
an air inlet (530) connected to the outside to allow outside air to be mixed into the inside of a venturi nozzle of which duct width is narrowed on the inner peripheral surface of the first and second orifices (510, 520), and an on-off valve (540) that controls the amount of outside air mixed into the inside of the first and second orifices (510, 520) through the air inlet (530)

3. The manufacturing system for coffee with bubbles according to claim 1, characterized by
the first and second orifices (510, 520) placed in series within a transfer hose (200) located at the rear side of the pump (300)
